(19) United States
(12) Patent Application Publication
(10) Pub. No.: US 2021/0035030 A1
(43) Pub. Date: Feb. 4, 2021

(54) TEE-TIME RESERVATION DISTRIBUTION AND ALERT PLATFORM

(71) Applicant: Sagacity Golf Technologies Inc., Portland, OR (US)

(72) Inventors: Brett Darrow, Tualatin, OR (US); Howard A. Seitz, Rye, NY (US); Duane Craw, Beaverton, OR (US)

(21) Appl. No.: 16/528,429

(22) Filed: Jul. 31, 2019

(51) Int. Cl. G06Q 10/02; G06F 3/0482; G06F 9/54

(52) U.S. Cl. CPC G06Q 10/02; G06F 9/542; G06F 3/0482

(57) ABSTRACT

Embodiments of the present disclosure provide for a tee-time reservation distribution and alert platform. Other embodiments may be described and claimed.

### FIELD

Embodiments of the present invention relate generally to the technical field of reservation systems.

### BACKGROUND

Reservations for playing a round of golf are typically referred to as tee-times. Historically, golf courses would manage these reservations by relying on printed tee-time sheets that would be filled in when a customer contacted the golf course to book a round. Increasingly, golf courses rely on electronic versions of the tee-time sheets that are hosted on a local computer, server, or cloud-architecture. The electronic tee sheets facilitate online reservations as well as increasingly sophisticated inventory management processes.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 illustrates a system in accordance with some embodiments.

FIG. 2 illustrates an operation flow/algorithmic structure in accordance with some embodiments.

FIG. 3 illustrates an operation flow/algorithmic structure in accordance with some embodiments.

FIG. 4 illustrates an operation flow/algorithmic structure in accordance with some embodiments.

FIG. 5 illustrates a page of a graphical user interface in accordance with some embodiments.

FIG. 6 illustrates a page of a graphical user interface in accordance with some embodiments.

FIG. 7 illustrates a page of a graphical user interface in accordance with some embodiments.

FIG. 8 illustrates a page of a graphical user interface in accordance with some embodiments.

FIG. 9 illustrates a page of a graphical user interface in accordance with some embodiments.

FIG. 10 illustrates an operation flow/algorithmic structure in accordance with some embodiments.

FIG. 11 illustrates a page of a graphical user interface in accordance with some embodiments.

FIG. 12 illustrates a page of a graphical user interface in accordance with some embodiments.

FIG. 13 illustrates a page of a graphical user interface in accordance with some embodiments.

FIG. 14 illustrates an example computing device to implement various aspects of the present disclosure, including components and operation flows/algorithmic structures described herein.

FIG. 15 is a block diagram illustrating computer-readable storage media and programming instructions to perform any one or more of the methodologies discussed herein.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A or B” and “A/B” mean (A), (B), or (A and B).

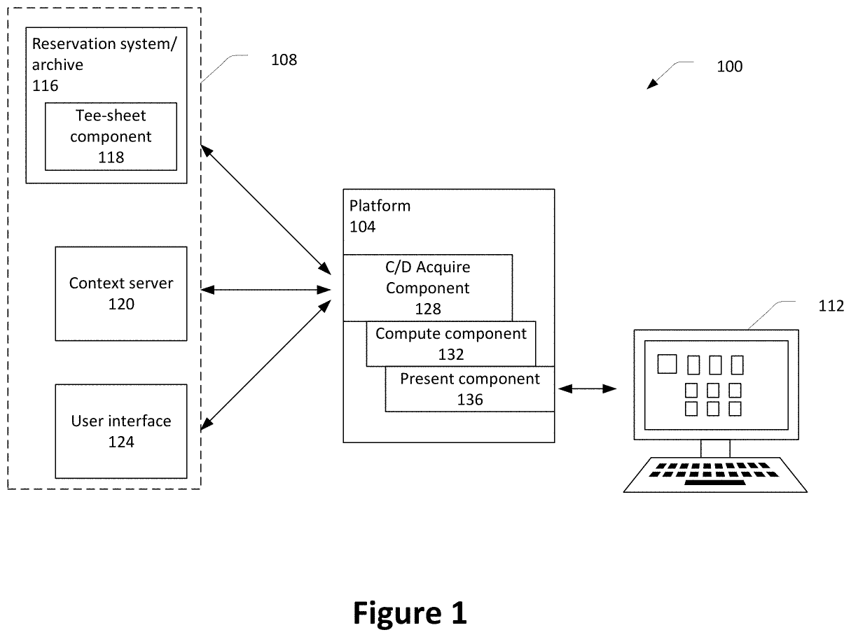

FIG. 1 illustrates a system 100 in accordance with some embodiments. The system may include a tee-time reservation distribution and alert platform 104 (hereinafter “platform 104”) communicatively coupled with sources 108 and a display device 112. In various embodiments, the coupling of the platform 104, sources 108, and display device 112 may be local or remote. For example, the platform 104 and the display device 112 may be disposed in a common computing system and may be coupled with one or more of the sources 108 over various networks, for example, personal area networks, wireless local area networks, wide area networks, etc. For another example, the platform 104 may be hosted in a server and remotely coupled with the display device 112 and the user interface 124. Any combination of remote/local coupling of the components of the system 100 may be used.

The sources 108 may include a reservations system/archive 116, a context server 120, and a user interface 124.

The reservations system/archive 116 may represent computing systems that store or otherwise have access to various current and historical data on tee-time reservations for one or more golf courses. In various embodiments, the reservations system/archive 116 may include an electronic tee sheet 118 that manages and has access to reservation data. In some embodiments, the reservations system/archive 116 may be a service provider that provides the electronic tee sheets, or an aggregator that collects, directly or indirectly, the relevant data from the golf courses.

The context server 120 may be a server to provide non-reservation information to the platform 104. For example, the context server 120 may provide weather data, geographical data, etc. to the platform 104.

The user interface 124 may source control information including, for example, input parameters, search requests, etc., to the platform 104. For example, the input parameters may be information that defines one or more periods of interest, golf courses, etc.

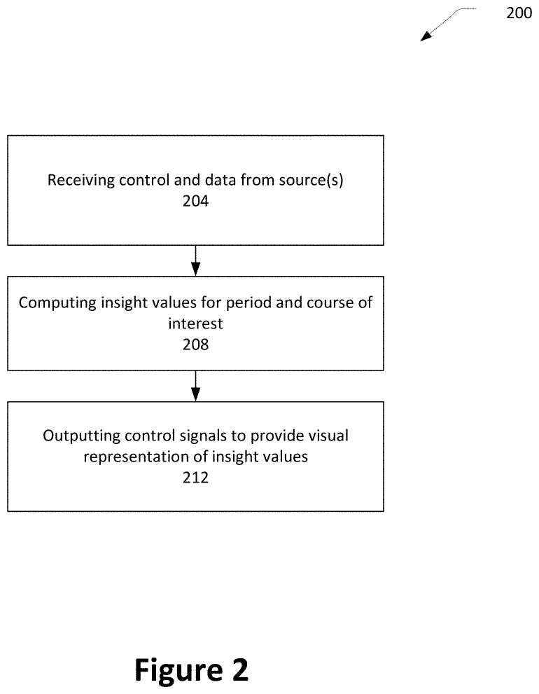

The platform 104 may include a plurality of components designed to collaboratively provide various aspects of the disclosed embodiments. In particular, the platform 104 may include a control/data (C/D) acquire component 108, a compute component 132, and a present component 136. Further description of operation of the components of the platform 104 are described with respect to the operation flow/algorithmic structures of FIGS. 2, 3, 4, and 10.

As used herein, “components” may refer to, be part of, or include software components that are to be executed by circuitry such as, but not limited to, an application specific integrated circuit (ASIC), an electronic circuit, a processor (for example, a central processing unit, a graphics processing unit, etc.). The components of platform 104 may include or be part of one or more software applications, computer program, application suites, enterprise software applications, etc. In some embodiments, the components may be developed for an online environment and include Hypertext Markup Language (HTML), JavaScript, or other web-native technologies that are to be executed by a web-browser. Depending on the specific architecture, the web browser may be hosted on the platform 104 or another platform, for example, a computing platform that includes the display device 112.

FIG. 2 illustrates an operation flow/algorithmic structure 200 in accordance with some embodiments. The operation flow/algorithmic structure 200 may be implemented by the platform 104 as described.

At 204, the operation flow/algorithmic structure 200 may include receiving control and data from sources 108. The receiving of the control and data may be performed by the C/D acquire component 128 interfacing with the various sources 108. In some embodiments, the user interface 124 may provide control signals that include input parameters or search requests to the C/D acquire component 128. The control signals may define a particular golf course and period of interest for which a subsequent analysis is to be performed.

In some embodiments, the C/D acquire component 128 may interface with sources 108 through a file transfer protocol (FTP), an RSS feed with a dynamically updated extensible markup language (XML) structure, email, or a publicly facing application programming interface (API). The data may be formatted in any of a variety of formats including, but not limited to, flat files, comma separated value (CSV) files, spreadsheet formats, etc.

In some embodiments, receipt of the control signals from the user interface 124 may initiate the operation flow/algorithmic structure 200. In other embodiments, the user interface 124 may configure the platform 104 to perform the operation flow/algorithmic structure 200 according to a schedule; or based on a satisfaction of predetermined criteria. Thus, each iteration of the operation flow/algorithmic structure 200 may not always be associated with separate control signals from the user interface 124 to instantiate the process.

The C/D acquire component 128 may acquire relevant data from the reservations system/archive 116 and the context server 120 based on the control signals provided by the user interface 124. The relevant data may include historical reservation data (for example, historical demand) and current reservation data (for example, current reservations) for the period of interest. The historical reservation data may include reservation data for both the particular golf course of interest and other golf courses in the same geographical area as the course of interest. In some embodiments, the control signals from the user interface 124 may define the geographical area.

At 208, the operation flow/algorithmic structure 200 may further include computing insight values for period and course of interest. The computing of the insight values for the period/course of interest may be performed by the compute component 132 interfacing with the C/D acquire component 128 to receive appropriate control and data signals.

The compute component 132 may process the current and historical reservation data for the period/course of interest in order to generate insight values that are uniquely designed to convey and predict trends associated with managing tee-time inventory. The insight values may be used by a golf-course operator to identify periods for which specific attention or action may be desired to achieve revenue or other operational targets. The insight values may be associated with the period of interest or specific tee-times within the period of interest. The insight values that may be generated by the compute component 132 include pace value; up/down category tallies; power hours; and hot hours. These insight values may be based on true and forecasted demand values calculated by the compute component 132. The true/forecasted demand values may, in turn, be based on current and historical reservation data as will be described in more detail herein.

Demand values (historical, forecasted, or true) may correspond to the number of tee-time reservations. In general, each tee-time will have up to four available reservations, as one tee-time is typically restricted to no more than four golfers.

At 212, the operation flow/algorithmic structure 200 may further include outputting control signals to provide visual representation of insight values. The outputting of the control signals may be performed by the present component 136 upon receipt of the insight values generated by the compute component 132 along with any other relevant data form the sources 108, for example, weather data.

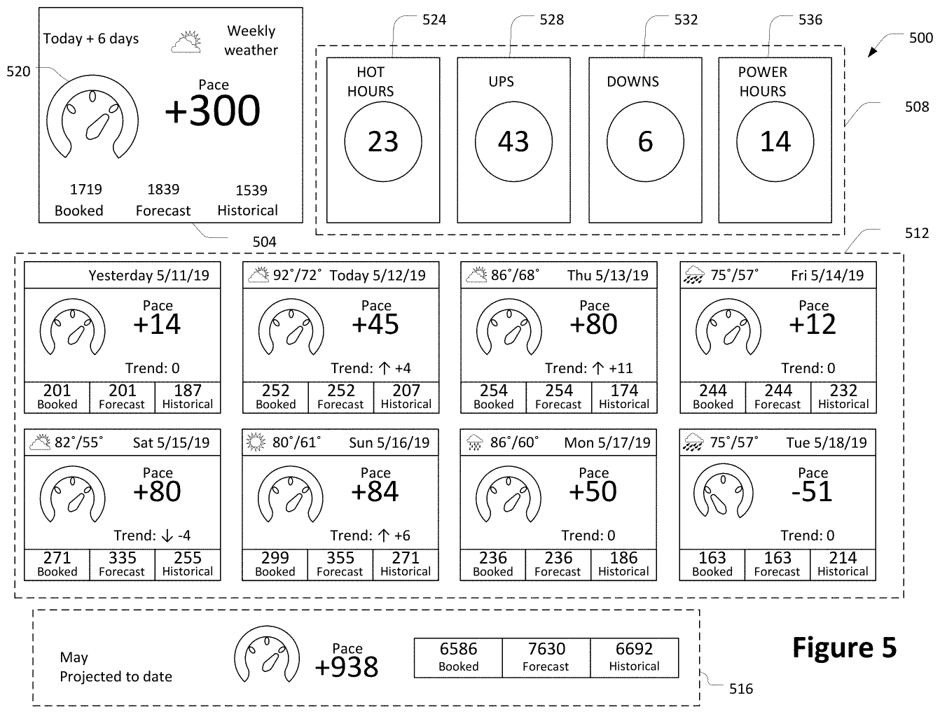

The control signals output by the present component 136 may be provided to the display device 112 to cause the display device 112 to output a graphical display of the insight values in a manner designed to efficiently convey the underlying reservation trend information relevant to the period/course of interest. The graphical display may be a mixture of graphical and numerical representations of the insight values as explained in further detail with respect to FIG. 5.

In some embodiments, the present component 136 may provide the insight values in a variety of pages of information, with each page having linkable structures that, when invoked, call other pages. Various example pages are shown and described in FIGS. 5-9, 11, and 12. Invocation of the links of a page may be based on feedback control signals provided to the present component 136 from the user interface 124 or another user interface, for example, a user interface associated with the display device 112.

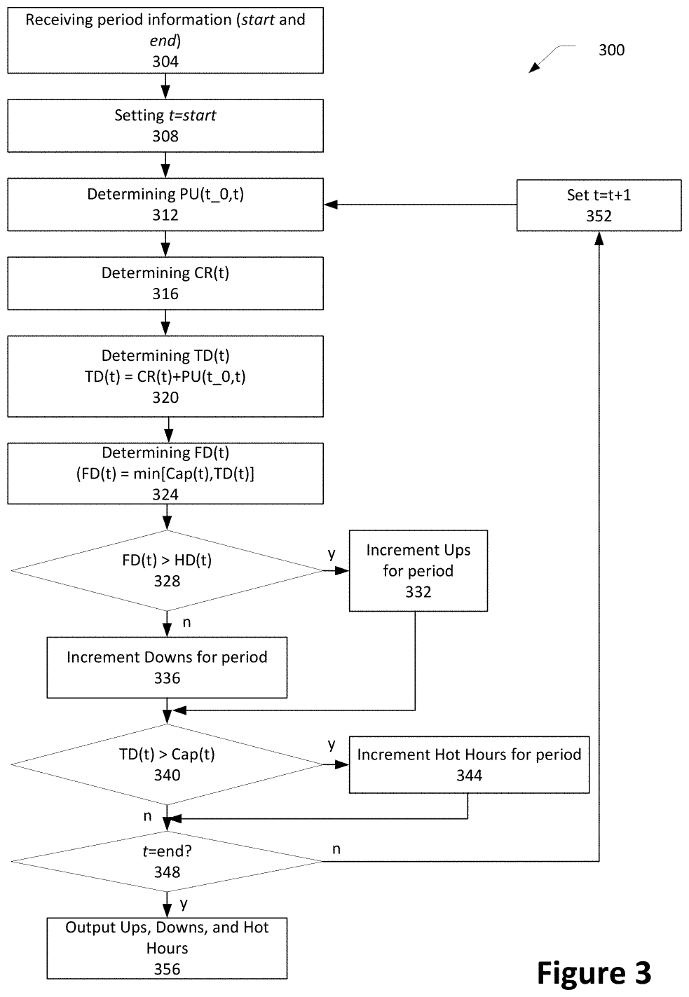

FIG. 3 illustrates an operation flow/algorithmic structure 300 in accordance with some embodiments. The operation flow/algorithmic structure 300 may be implemented by the compute component 132 to provide insight values including up category tallies (also referred to as “Ups”), down category tallies (also referred to as “Downs”), and hot hours.

At 304, the operation flow/algorithmic structure 300 may include receiving period information. The period information may be received from the user interface 124 via the C/D acquire component 128 and may define the period of interest. The period information may include an indication of a start time period, start, and an end time period, end, that define the period of interest. For example, the period of interest may be one week with the start-time information, start, being a first occurring tee-time period of a current date and the end-time information, end, being the last occurring tee-time period in six days from current date. While many of the embodiments may describe the period of interest as one week, the period of interest may be any other period of time.

The tee-time periods may be hours, with each hour having a certain number of tee-times. Typically, tee-times are separated from one another by 8-12 minutes. In various embodiments, different tee-time periods may include different number of tee times that may or may not relate to different time intervals.

The period of interest may include all tee-time periods between the start time and the end time or a subset of the tee-time periods that share a common trait, for example, a common rate. For example, some golf courses may provide different rates for different times of the day. For example, a golf course may have a discounted, twilight, rate for tee times that occur later in the day; an early-bird rate for tee times that occur early in the morning, etc.

At 308, the operation flow/algorithmic structure 300 may include setting a time period of analysis, t, equal to the starting time period, start.

At 312, the operation flow/algorithmic structure 300 may include determining a pickup value from a current time to the time period of analysis, PU(t_0, t). The pickup value may be a number of reservations historically picked up between the current time and the time period of analysis. The pickup value may be based on one or more similar time periods in the past. For example, the pickup value may be based on the number of reservations picked up last n years for the same time periods, where n can be any positive integer, but may often be between one and three. In some embodiments, the pickup value may be based on a current year's reservation data. For example, the pickup value may be based on the number of reservations picked up the last n weeks for the same time periods. In some embodiments, n may be restricted to the same season associated with the time period of analysis in order to maintain a relationship between the two data sets.

At 316, the operation flow/algorithmic structure 300 may include determining a number of current reservations for the time period of analysis, CR(t). The number of current reservations, or bookings, may be provided from the tee-sheet component 118. In some embodiments, the number of current reservations may be received by directly querying the tee-sheet component 118, or by accessing periodic updates to a database accessible by the compute component 132.

At 320, the operation flow/algorithmic structure 300 may include determining a true demand for the time period of analysis, TD(t). The true demand, which may also be referred to as “unconstrained demand,” may refer to a number of tee-times that may be sold for the time period of analysis if inventory was not a constraining factor. The true demand for the time period of analysis may be equal to the number of current reservations for the time period of analysis plus the number of reservations historically picked up between the current time and the time period of analysis, for example, TD(t)=CR(t)+PU(t_0,t).

At 324, the operation flow/algorithmic structure 300 may include determining the forecasted demand for the time period of analysis, FD(t). The forecasted demand may be based on a comparison of the capacity of the time period of analysis, Cap(t), and the true demand. In particular, the forecasted demand may be set equal to the lesser of the capacity of the time period of analysis, Cap(t), and the true demand, for example, FD(t)=min[Cap(t),TD(t)].

Assuming, for example, a 10-minute frequency interval for the tee-times, and further assuming all tee-times are available for the time period of analysis, the capacity for a particular hour may be 24 reservations (6 tee-times×4 golfers per tee-time). The tee-sheet component 188 may provide capacity information, for example, a total number of tee-time reservations (booked or not) of the time period of analysis, to the platform in a dynamic, event-driven, or periodic manner.

At 328, the operation flow/algorithmic structure 300 may further include determining whether the forecasted demand for the time period of analysis is greater than the historical demand, for example, whether FD(t)>HD(t). Similar to said determination of the pickup value, the historical demand for a time period of analysis may look at historical reservation data of an associated tee-time period. In some embodiments, the associated tee-time period may be the same tee-time period of the previous year/week or an average of the same tee-time period of a previous number of years/weeks.

If it is determined at 328 that the forecasted demand is greater than the historical demand, the operation flow/algorithmic structure 300 may further include, at 332, incrementing the Ups for the period of interest.

If it is determined at 328 that the forecasted demand is not greater than the historical demand, the operation flow/algorithmic structure 300 may further include, at 336, incrementing the Downs for the period of interest.

At 340, the operation flow/algorithmic structure 300 may further include determining whether a true demand for the time period of analysis is greater than a capacity, for example, whether TD(t)>Cap(t).

If it is determined at 340 that the true demand is greater than the capacity, the operation flow/algorithmic structure 300 may further include, at 344, incrementing the Hot Hours for the period of interest. Thus, the inequality TD(t)>Cap(t) may be a threshold condition for determining whether the time period of analysis is in a high-demand category and may, therefore, be referred to as a Hot Hour.

In some embodiments, the compute component 132 may control one or more counters to track the Ups, Downs, and Hot Hours. The counters may be hardware or software disposed on the platform 104 that may be incremented/decremented/reset based on appropriate instructions from the compute component 132.

At 348, the operation flow/algorithmic structure 300 may further include determining whether the time period of analysis equals the end period, for example, whether t=end.

If it is determined at 348 that the time period of analysis does not equal the end period, the operation flow/algorithmic structure 300 may further include, at 352, incrementing the time period of analysis by one, for example, setting t=t+1, and advancing to 312.

If it is determined at 348 that the time period of analysis does equal the end period, the operation flow/algorithmic structure 300 may further include, at 356, outputting the Ups, Downs, and Hot Hours for the period of interest.

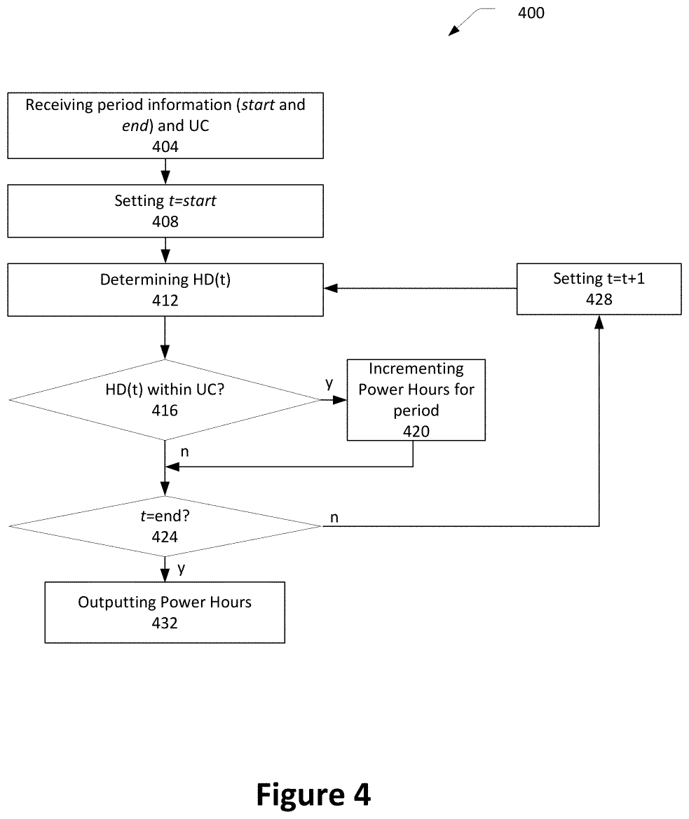

FIG. 4 illustrates in operation flow/algorithmic structure 400 in accordance with some embodiments. The operation flow/algorithmic structure 400 may be implemented by the compute component 132 to provide insight values including power hours. The operation flow/algorithmic structure 400 may be implemented in conjunction with, or separate from the operation flow/algorithmic structure 300.

At 404, the operation flow/algorithmic structure 400 may include determining a period of interest and a utilization category. The information defining the period of interest and selected utilization category may be received from the user interface 124 via the C/D acquire component 128. The information defining the period of interest may include an indication of a start time period, start, and an end time period, end. The period of interest may be, for example, one day, one week, one month, or one year.

The utilization category may be a percentage range such as, but not limited to, top 20%, top 10%, top 5%, or top 1% utilization.

At 408, the operation flow/algorithmic structure 400 may include setting a time period of analysis, t, equal to the starting time period, start.

At 412, the operation flow/algorithmic structure 400 may include determining a historical demand for the time period of analysis. The historical demand for the time period of analysis may be based on historical reservation data of an associated tee-time period for one or more golf courses within a particular geographical region. The geographical region may define golf courses in the same area as the golf course for which the Ups, Downs, and Hot Hours are determined by operation flow/algorithmic structure 300. In some embodiments, the geographical region may be selectable by control signals received from the user interface 124.

Similar to operation flow/algorithmic structure 300, the associated tee-time period may be the same tee-time periods of the previous year/week or an average of the same tee-time period of a previous number of years/weeks.

At 416, the operation flow/algorithmic structure 400 may include determining whether the historical demand for the time period of analysis is within the set of the utilization category. For example, if the selected utilization category is the top 20%, the compute component 132 may determine, whether the historical demand for the time period of analysis is within the top 20% of all historical demand for the one or more golf courses of the geographical region.

If it is determined, at 416, the historical demand is within the utilization category, the operation flow/algorithmic structure 400 may advance to incrementing a Power Hours for the period at 420. The incrementing of the Power Hours may be performed by the compute component 132 controlling a counter.

Following 420, or if it is determined, at 416, the historical demand is not within the utilization category, the operation flow/algorithmic structure 400 may advance to determining whether the time period of analysis equals the end period, for example, whether t=end.

If it is determined that 424 that the time period of analysis does not equal the end period, the operation flow/algorithmic structure 400 may further include, at 428, incrementing the time period of analysis by one, for example, setting t=t+1, and advancing to 412.

If it is determined at 424 that the time period of analysis does equal the end period, the operation flow/algorithmic structure 400 may further include, at 432, outputting the Power Hours for the period of interest.

FIG. 5 illustrates a page 500 of a graphical user interface that includes both graphical and numerical indications of insight values and other data in accordance with some embodiments. The page 500 may be generated by the display device 112 based on control signals transmitted by the present component 136.

The page 500 may include represent information related to a period of interest that is one week, shown as today plus six days.

The page 500 may include a summary graphic 504, an insight-values section 508, sub-periods section 512, and a macro-periods section 516.

The summary graphic 504 may provide numerical indications of booked values (corresponding to “current reservations”), forecasted values (corresponding to “forecasted demand”), and historical values (corresponding to “historical demand”) for the period of interest. These values may be obtained by the platform 104 as described hereinabove.

The summary graphic 504 may also provide both numerical and graphic indications of a pace for the period of interest. The pace may be equal to forecasted value minus an historical value for a particular period of interest. For the page 500, the forecasted value for the period of interest is 1839 while the historical value is 1539, thereby providing a pace of +300. Along with the numerical indication of the pace, the summary graphic 504 provides a gauge chart 520 to provide a graphic indication of the pace. The gauge chart 520 may have a dial that turns clockwise to represent high pace values and counterclockwise to represent low or negative pace values. In some embodiments, the gauge chart 520 may also include color coding to indicate certain pace values. For example, when the pace values are high, some or all of the gauge chart 520 may be highlighted in a certain color, for example, green; and when the pace values are low, some or all of the gauge chart 520 may be highlighted in a different color, for example, red.

The gauge chart 520 may provide a visible alert system that identifies positive, neutral, or negative trends in reservation activity. A golf course operator may initially rely on this visible alert system to focus attention on areas that need further analysis, which may be performed based on the accompanying numerical indications of page 500 or links to other pages as will be discussed in further detail.

The summary graphic 504 may also include an indication of the defined period of interest, for example, today+6 days, and a weather object that may serve as a link to a weather forecast for the period of interest.

The insight-values section 508 may include prominent displays of numerical representations of the insight values that correspond to the period of interest. In particular, the insight-values section 508 may include Hot Hours 524, Ups 528, Downs 532, and Power Hours 536. These values may be obtained as described above with respect to operation flows/algorithmic structures 200, 300, or 400.

The Hot Hours 524 may provide an indication of how many tee-time periods within the period of interest include a forecasted total demand that is greater than a capacity. In this embodiment, the Hot Hours 524 indicates a total of 23 tee-time periods have a forecasted demand that is greater than the capacity.

The Ups 528 may provide an indication of how many tee-time periods within the period of interest include a forecasted demand that is greater than a historical demand. In this embodiment, the Ups 528 indicates a total of 43 tee-time periods have a forecasted demand that is greater than the historical demand.

The Downs 532 may provide an indication of how many tee-time periods within the period of interest include a forecasted total demand that is less than a historical demand. In this embodiment, the Downs 532 indicate a total of 6 tee-time periods have a forecasted demand that is less than the historical demand.

The Power Hours 536 may provide an indication of how many tee-time periods within the period of interest are included as top market hours. The top market hours may be those tee times that are associated with a historical demand over one or more golf courses within a geographical area and predetermined utilization categories. In this embodiment, the Power Hours may display the most inclusive predetermined utilization category of a particular embodiment, for example, top 20% if power-hour utilization categories include top 20%, 10%, 5%, and 1%.

The sub-periods section 512 may provide separate summary graphics for each of the sub-periods within the period of interest. In particular in accordance with this embodiment, the sub-periods section 512 includes daily summary graphics for each day of the week beginning with a current day. In some embodiments, the sub-periods section 512 may also show one or more sub- or other periods that are not included in the period of interest. For example, sub-periods section 512 also includes a yesterday summary graphic even data related to yesterday is not included in the weekly summary graphic 504.

Each of the daily summary graphics may include numerical indicators for booked, forecast, historical, and pace. The daily summary graphics may also include a numerical/graphic trend indicator. The trend, as used herein, may refer to how much the pace has changed over a previous period, for example, since the beginning of the previous 24-hour period.

The daily summary graphics may also include a weather object with a graphic to indicate a weather forecast for the day along with predicted high/low temperatures.

The daily summary graphics may also include, similar to the weekly summary graphic 504, a gauge chart to provide a visual indication of the pace associated with the respective day.

The macro-periods section 516 may include a pace gauge chart and numerical values for pace, booked, forecast, and historical for a period of time that encompasses the period of interest. As shown, the macro-periods section 516 may include information for the month in which the period of interest occurs.

In this manner, various organizational levels of the insight values may be summarily displayed on a single page. The objects within the page 500 may be linkable to other pages of information, with each page having more detailed information or alternative presentations for the linked object.

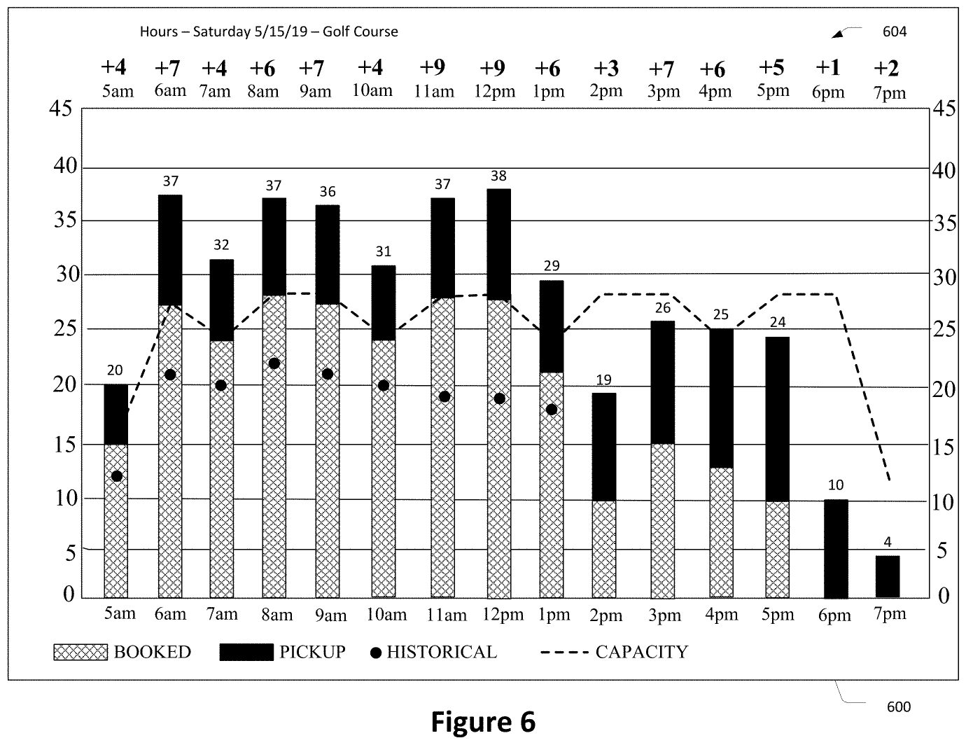

FIG. 6 illustrates another page 600 of the graphical user interface in accordance with some embodiments. The page 600 may be linked to the daily summary graphic for Saturday, 5/16/18, shown in page 500.

The page 600 may include a bar graph that provides information for each tee-time period (for example, hour) of the linked sub-period (for example, Saturday).

A bar graph for a particular hour may graphically illustrate booked and pickup values for each hour, with the combined bar graph illustrating the true demand, which is also included as a numerical value on top of each bar graph. The bar graphs may also graphically illustrate a historical value and capacity for the hour.

The page 600 may also include numerical indicators 604 of the pace value for each hour. The total pace values for each hour equals the pace value shown in the daily summary chart for Saturday on page 500, for example, +80.

Page 600 provides a quick visual representation of daily trends that may compel a golf course operator to perform rate adjustments or discounts for certain time periods. For example, the page 600 shows that, with the exception of 4 pm, all tee-times after 1 pm have a true demand less than the capacity. Thus, providing a discounted twilight rate starting at 2 pm may increase overall revenues for the day.

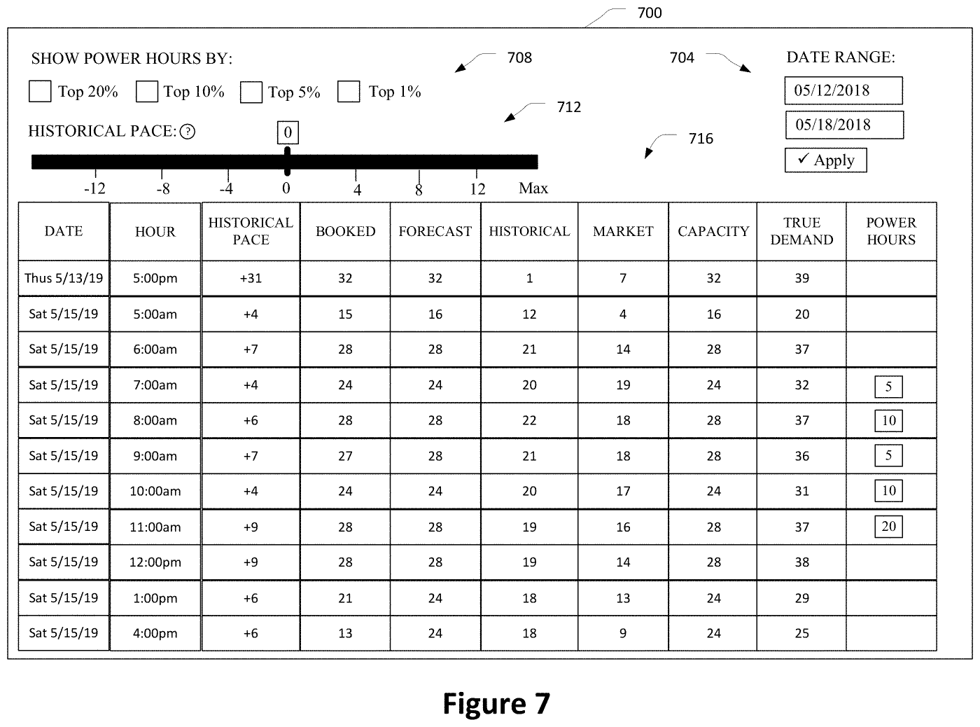

FIG. 7 illustrates a page 700 of the graphical user interface in accordance with some embodiments. The page 700 may include information associated with tee-times having selected pace values.

The page 700 may include a selectable date range 704, selectable utilization categories 708, a historical pace graph 712, and table 716.

The selectable date range 704 may be a range that limits information displayed on page 700. By default, the dates may correspond to the period of interest of page 500. However, these date ranges may be changed to any period of interest to examine associated tee-times.

A historical pace bar graph 712 may be used to provide the pace values that define the tee-times shown on page 700. Set at zero, as shown, the page 700 may show all tee-times within the selectable date range 704 that have a pace value greater than zero. If moved in the indicator is moved to a negative value, the page 700 may show all tee-times within the selectable date range 704 that have a pace value more negative than the negative value.

The selectable utilization categories 708 may define different power-hour levels to which the entries of page 700 are restricted. As shown, top 20%, 10%, 5%, and 1% power-hours are available; however, in other embodiments, additional/alternative categories may be used.

The table 716 may include rows corresponding to each power hour in the selected date range. The table 716 may include columns providing, for respective power hours, date, hour, historical pace, booked, forecast, historical, market (average number of rounds sold for all courses), capacity, true demand, and power hours category.

The market value, as used herein, may refer to an average number of rounds sold for all courses of a data set (for example, all courses within the same geographical region as the course of interest).

The power hours category may show which tee-times of page 700 are in one of the power-hour categories. As shown, the 7:00 am tee-time on Saturday, May 15, is in the top 5 power-hour category; 8:00 am tee-time is in the top 10 power-hour category; etc. It may be noted that the power-hour category with which a tee-time is associated is the highest category. For example, while the 7:00 am tee-time is in the top 5%, 10%, and 20%, it is considered in the top 5 power-hour category as that is the highest category.

The information provided by page 700 may give an operator further insight into demand characteristics within the marketplace. For example, the tee-time reservation at 9 AM on Saturday is a top-5 power hour. Thus, an operator will understand that demand will be consistently high across all golf courses associated with the data set. An increase in the price of the 9 AM tee-time may, therefore, be associated with a relatively smaller drop in demand as compared to a non-power hour.

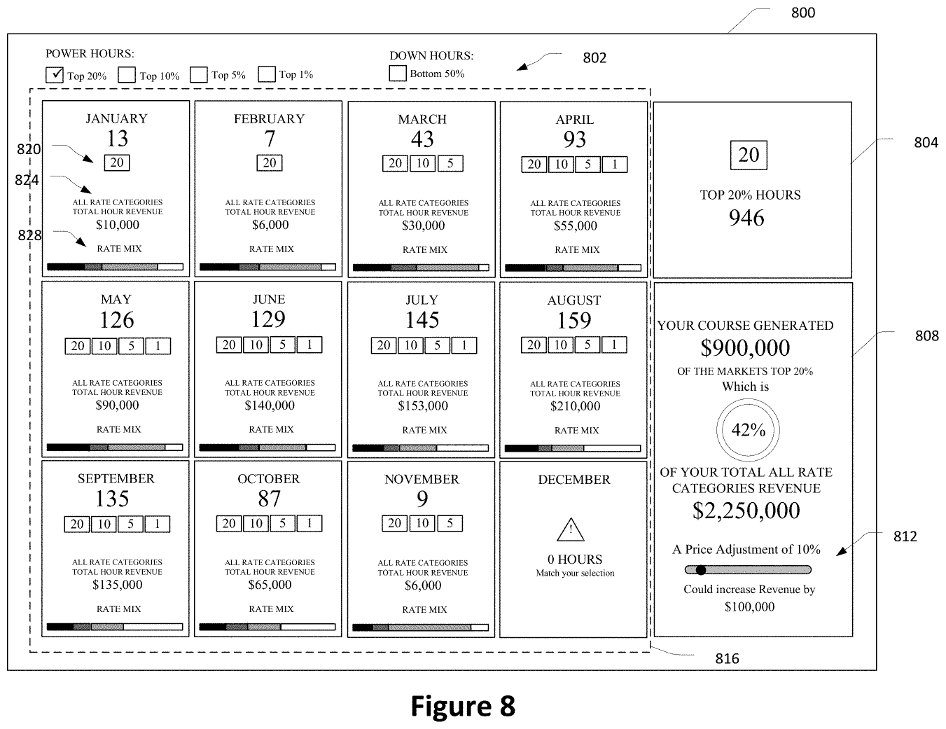

FIG. 8 illustrates a page 800 of the graphical user interface in accordance with some embodiments. The page 800 may be a summary of a particular power-hour category.

The page 800 may include a category selector 802 to select one or more power-our categories, and an indication 804 to indicate the selected power-hour category, which will define the information displayed by the page 800. In this embodiment, the category selector 802 is shown selecting top-20 power-hour category. The indication 804 then shows that, of the current calendar year, the top-20 power hour categories may include 946 entries.

In addition to the four power-hour categories, page 800 also includes a down-hour category that may correspond to a bottom 50% utilization category.

The page 800 may provide a financial summary 808 that is associated with the particular power-hour category. In this embodiment, the financial summary 808 may indicate that top-20 power hours are responsible for 42% ($900,000 out of the total $2,250,000) of the yearly revenue for the golf course.

The financial summary 808 may also include the slide graph 812 that provides an correlation between a price adjustment and revenue. The slide graph 812, as set, indicates a 10% increase for all rate categories of the top-20 power hours could increase the total revenue by $100,000. The slide graph 812 may be adjusted for various price increases/decreases.

The page 800 may further include monthly summaries 816. Each of the monthly summaries 816 may include icons 820 to indicate which power-hour categories are included in a particular month, a revenue number 824 that provides revenue generated by the top-20 power hours of that particular month; and a bar graph 828 to provide a visual indication of a rate mix for a particular month. The bar graphs 828 shown in FIG. 8 illustrate proportional amounts of tee-times with four different rate categories. However, in other embodiments other numbers of rate categories may be used.

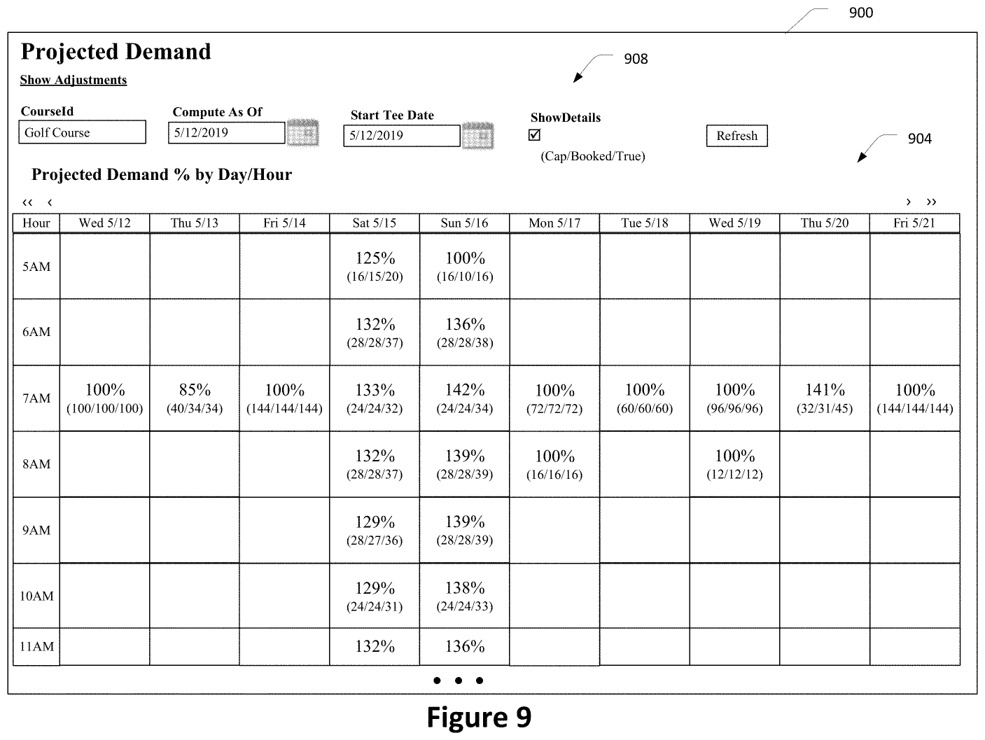

FIG. 9 illustrates a page 900 of a graphical user interface in accordance with some embodiments. The page 900 may illustrate a timetable 904 of tee-time periods to provide a true demand v. capacity (TDvC) percentage in accordance with some embodiments. Blank fields may indicate that no tee-times are available (for example, due to a golf tournament, course repair, etc.)

The page 900 may include input fields 908 providing course identifier, computation date, and starting tee-time date. The values provided in the input fields 908 may be used by the compute component 132 to generate the TDvC percentages. For example, on May 12, the compute component 132 may determine TDvC values associated with the various tee-time periods starting on May 12. Referring, in particular, to 7 AM on Saturday, May 15, the compute component 132 may calculate the TDvC percentage as 133% based on underlying values of a capacity value equal to 24 and a true demand value equal to 32.

Page 900 may provide an operator with a quick visual reference of tee-time periods having true demands greater (or less than) capacity values. The larger the TDvC percentage varies from 100%, the greater the opportunity to increase revenue by pricing adjustments, increasing advertising efforts, etc.

While page 900 provides TDvC percentages, other embodiments may provide, or otherwise rely on other metrics based on true demand. For example, in some embodiments, true demand v. historical demand (TDvHD) percentages may be computed and relied on in a manner similar to TDvC percentages.

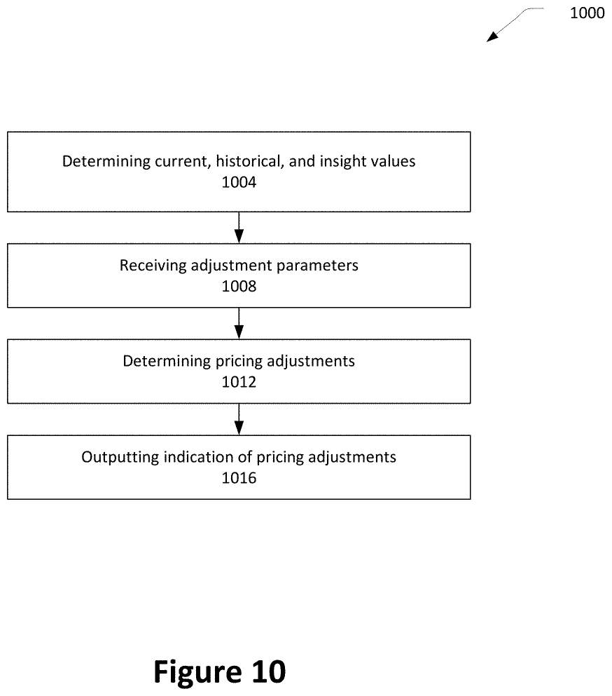

FIG. 10 illustrates an operation flow/algorithmic structure 1000 to provide pricing adjustments in accordance with some embodiments. The operation flow/algorithmic structure 1000 may be performed by the platform 104 in accordance with some embodiments.

The operation flow/algorithmic structure 1000 may include, at 1004, determining current, historical, or insight (CHI) values. The CHI values may include, for example, current reservations, true demand, forecasted demand, and historical demand. The CHI values may be determined as described in association with, for example, operation flows/algorithmic structures 200, 300, or 400.

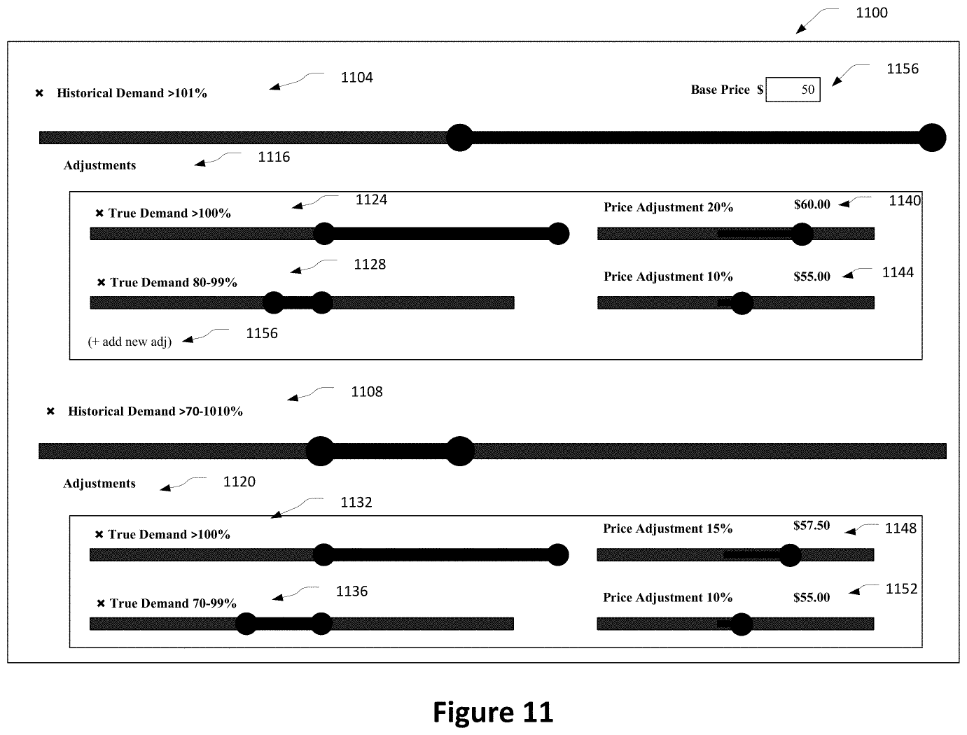

The operation flow/algorithmic structure 1000 may further include, at 1008, receiving adjustment parameters. In some embodiments, the platform 104 may receive the adjustment parameters from the user interface 124. In some embodiments, the adjustment parameters may be solicited from a user with a page 1100 as shown in FIG. 11 in accordance with some embodiments

The page 1100 may include one or more historical demand categories, for example, historical demand categories 1104 and 1108. Each historical demand category may further include an adjustment section, for example, historical demand category 1104 may include adjustment section 1116 and historical demand category 1108 may include adjustment section 1120.

Each adjustment section may include an adjustment with a true demand category and an associated pricing adjustment. For example, adjustment section 1116 may include true demand categories 1124 and 1128 respectively associated with price adjustments 1140 and 1144; and adjustment section 1120 may include true demand categories 1132 and 1136 respectively associated with price adjustments 1148 and 1152. The adjustment sections may also include a control object 1156 to add additional adjustments.

The pricing adjustments may be applied to various tee-times on a tee-time sheet. For illustration, page 1100 shows the pricing adjustments relative to a reference base price provided in field 1156. For example, with price adjustment 1140 is a 20% adjustment, resulting in $60. The base price may or may not be tied to existing tee-time prices.

Each of the historical demand categories, true demand categories, and pricing adjustments may include a sliding bar graph operable to set their respective ranges or values. The values for the historical and true demands may be percent values based on capacities of corresponding tee-time periods.

Referring again to FIG. 10, the operation flow/algorithmic structure 1000 may further include, at 1012, determining price adjustments. In some embodiments, the compute component 132 may determine pricing adjustments for respective tee time periods based on associated CHI values.

Consider, for example, a 6 AM tee time period on Saturday, May 15 having and historical demand value of 79% and a true demand value of 132%. With reference to the adjustment parameters illustrated in FIG. 11, the historical demand would place the tee-time period in historical demand category 1108 and the true demand value will place the tee-time period in true demand category 1132. Therefore, the tee-time period may be associated with pricing adjustment 1148, which is set at 15%.

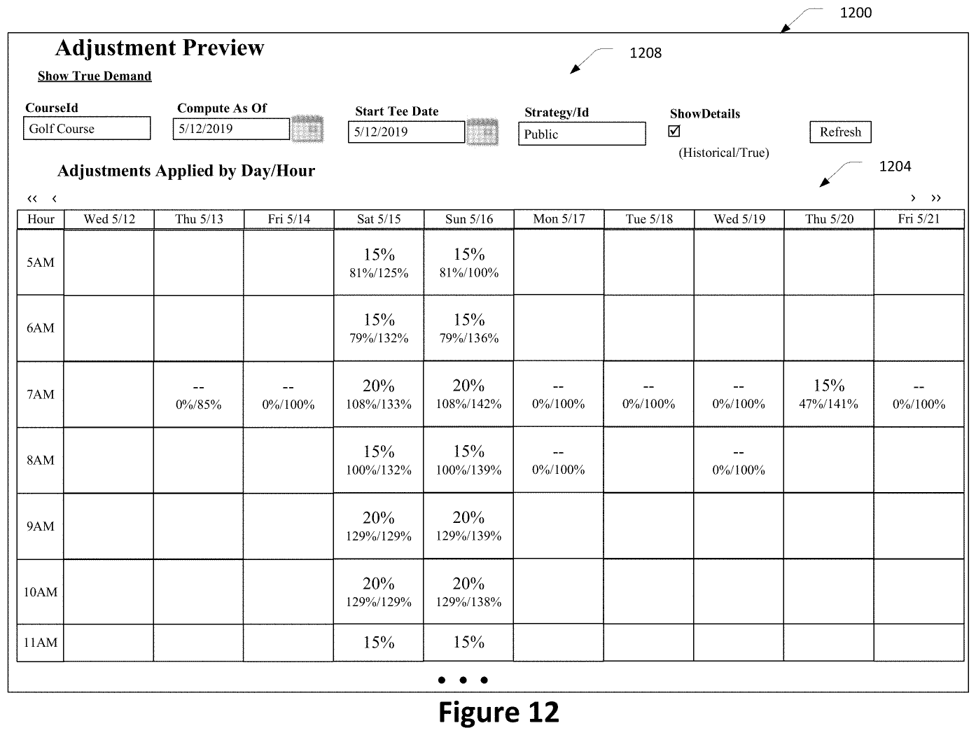

The operation flow/algorithmic structure 1000 may further include, at 1016, outputting an indication of pricing adjustments. In some embodiments, the compute component 132 may provide may provide the present component 136 with the indication of pricing adjustments, and the present component 136 may provide the display 112 with control signals to output page 1200 of FIG. 12 in accordance with some embodiments.

Page 1200 may include a timetable 1204 of tee-time periods with indications of corresponding pricing adjustments.

The page 1200 may include input fields 1208 providing a course identifier, computation date, and starting tee-time date. The values in the input fields 1208 may be used to acquire the CHI values at 1004 and may serve as a basis for the price adjustments determined at 1012.

The timetable 1204 may show, for the individual tee-time periods, a percentage pricing adjustment along with the percentage values for historical demand and true demand. For example, the 6 AM tee time period on Saturday, May 15 is shown to include the 15% pricing adjustment based on underlying historical and true demand percentage values of 79% and 132%, respectively.

In some embodiments, the outputting of the indication of pricing adjustments at 1016 may serve as a recommendation for an operator to consider re-pricing tee-times. However, in other embodiments, the platform 104 may automatically implement the pricing adjustments within an electronic tee sheet hosted by the platform 104 or another computing device, for example, reservation system/archive 116.

In some embodiments, the pricing adjustments may be made available by push notifications. This may be especially useful in the case of downward pricing adjustments.

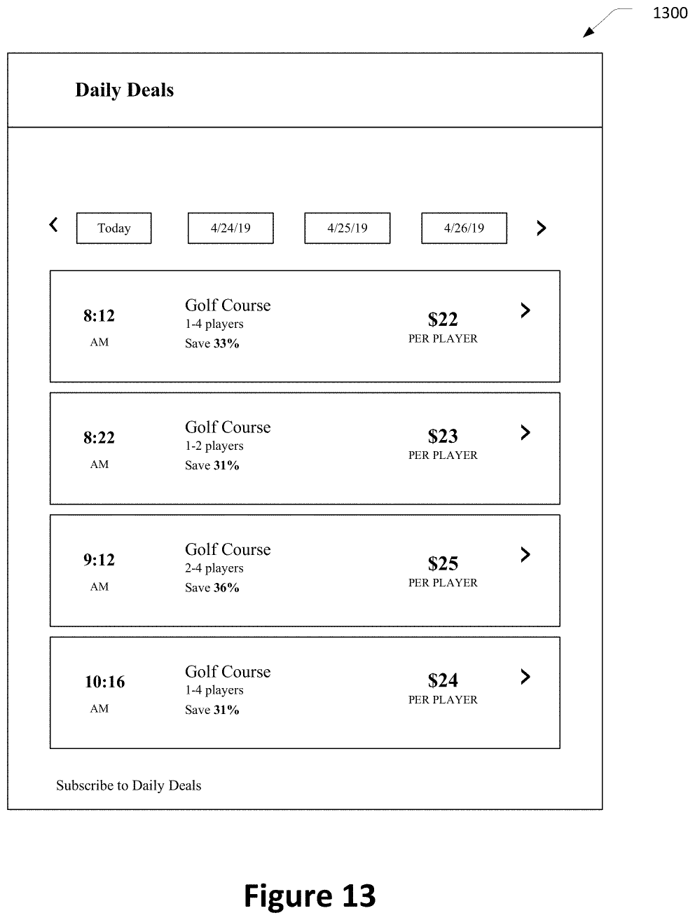

FIG. 13 illustrates a page 1300 of a graphical user interface in accordance with some embodiments. The page 1300 may advertise selected tee-time reservations. The page 1300 may be generated by the reservations system/archive 116 based on any of a variety of metrics received from the platform 104. In some embodiments, the deals page 1300 may be generated to show available tee-times having a downward pricing adjustment greater than predetermined threshold. In other embodiments, the deals page 1300 may be generated to show available tee-times having a pace value that is less than (or greater than) a predetermined threshold. In some embodiments, the predetermined thresholds may be configured by a user via control signals provided by the user interface 124.

The page 1300 may include tee-time advertisements that indicate reservation details such as, but not limited to, a tee-time, cost, course, number of players, and percentage discount that is associated with a period in which the tee-time resides. In this manner, increasingly aggressive discounts may be configured to be automatically implemented and advertised in order to provide inventory, having an associated true demand or pace value that puts the inventory at risk for spoilage, with an increased chance for utilization.

The page 1300 may be delivered by any of a number of delivery mechanisms designed to target potential customers. For example, the page 1300 may be a pop-up window on an associated webpage, may be delivered by email or other messaging platforms, etc.

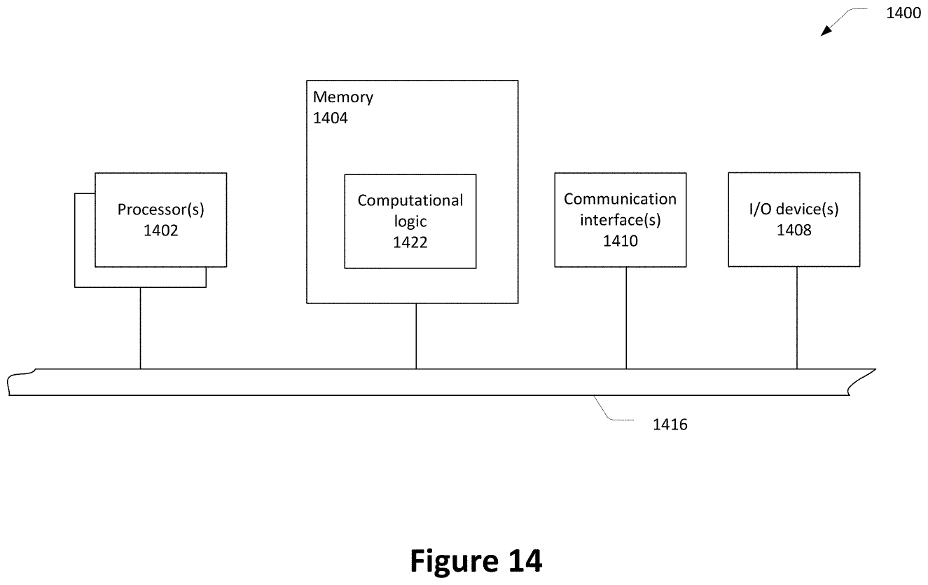

FIG. 14 illustrates an example computing device to implement various aspects of the present disclosure, including components and operation flows/algorithmic structures described herein. In various embodiments, the computing device 1400 may be implemented as the platform 104, display 112, reservation system/archive 116, or user interface 124 shown and described with respect to FIG. 1.

The computing device 1400 may include one or more processors or processors 1402 and memory 1404. For the purpose of this application, including the claims, the terms “processor” and “processor cores” may be considered synonymous, unless the context clearly requires otherwise.

The memory 1404 may include any combination of volatile and non-volatile memory. For example, the memory 1404 may include random access memory (for example, dynamic random access memory, synchronous dynamic random access memory, static random-access memory, non-volatile random-access memory etc.), read-only memory (for example, mask read-only memory, programmable read-only memory, erasable programmable read-only memory, electrically erasable programmable read-only memory, flash memory, etc.), caches, etc. Some elements of the memory 1404, for example, mass storage may be physically separate or remote from the computing device 1400.

The memory 1404 may be employed to store component logic 1422 including, for example, working or permanent copies of programming instructions, to implement operations associated with described components (for example, c/d acquire component 128, compute component 132, present component 136, tee-sheet component 118, etc.). The various elements of the component logic 1422 may be implemented by assembler instructions supported by processor(s) 1802 or high-level languages, such as, for example, C and/or any of the other high-level languages discussed herein, that can be compiled into such instructions.

The permanent copy of the programming instructions may be placed into permanent storage devices in the factory, or in the field through, for example, a distribution medium (not shown), such as a compact disc (CD), or through communication interface 1810 (from a distribution server (not shown)). That is, one or more distribution media having an implementation of the operation flows/algorithmic structures described herein may be employed to distribute the programming instructions and program various computing devices.

The processors 1402 may include any combination of processing circuitry to execute the computational logic 1422 from the memory 1404 to implement various aspects of the embodiments described herein. The processors 1402 may include central processing units, graphics processing units, digital signal processors, accelerators etc. The processors 1402 may be implemented on a common motherboard, dedicated cards, etc. The processors 1402 may further include various units dedicated to specific processing tasks such as, but not limited to, power management units, bus interfaces, memory controllers, device drivers, display interfaces, compute/graphics arrays, registers, combinational logic, etc.

The computing device 1400 may further include input/output (I/O) devices 1408 (such as display, keyboard, cursor control, remote control, gaming controller, image capture device, and so forth). In some embodiments, the I/O devices 1408 may include or correspond to user interface 124, display 112, etc.

The computing device 1400 may further include communication interface(s) 1410 that include one or more hardware devices that allow the computing device 1400 to communicate with other devices. In embodiments, each of the communication interfaces 1410 may include one or more processors (for example, baseband processors, etc.) that are dedicated to a particular wireless communication protocol (for example, Wi-Fi and/or IEEE 802.11 protocols), a cellular communication protocol (for example, Long Term Evolution (LTE), 5G, and the like), a wireless personal area network (WPAN) protocol (for example, IEEE 802.15.4-802.15.5 protocols, Bluetooth or Bluetooth low energy (BLE), etc.), or a wired communication protocol (for example, Ethernet, Fiber Distributed Data Interface (FDDI), Point-to-Point (PPP), etc.). The communication interfaces 1410 may also include hardware devices that enable communication with wireless/wired networks and/or other computing devices using modulated electromagnetic radiation through a solid or non-solid medium. Such hardware devices may include switches, filters, amplifiers, antenna elements, receptacles/ports to accept plugs/connectors, and/or and the like to facilitate the communications over the air or through a wire by generating or otherwise producing radio waves to transmit data to one or more other devices, and converting received signals into usable information, such as digital data, which may be provided to one or more other components of computing device 1400.

The elements of the computing device 1400 may be coupled to each other via internal connection interface 1416, which may represent one or more buses or other connections. In the case of multiple buses, they may be bridged by one or more bus bridges (not shown).

The number, capability and/or capacity of the elements of the computing device 1400 may vary, depending on how the computing device 1400 is used. Their constitutions are otherwise known, and accordingly will not be further described.

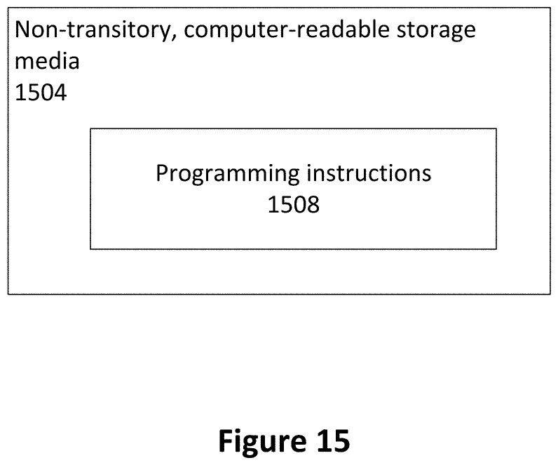

FIG. 15 illustrates an example least one computer-readable storage medium 1504 having instructions configured to practice all or selected ones of the operations associated with techniques described herein. As illustrated, least one computer-readable storage medium 1504 may include a number of programming instructions 1508. Programming instructions 1508 may be configured to enable a device, for example, computing device 1400, in response to execution of the programming instructions, to perform, for example, various operations of processes described herein, but not limited to, to the various operations performed to generate/output insight values (or their representations), pricing adjustments, advertisements, etc. In alternate embodiments, programming instructions 1508 may be disposed on multiple computer-readable storage media 1504 instead.

Computer-readable media (including least one computer-readable media), methods, apparatuses, systems and devices for performing the above-described techniques are illustrative examples of embodiments disclosed herein. Additionally, other devices in the above-described interactions may be configured to perform various disclosed techniques

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims.

### EXAMPLES

Example 1 may include: determining a first period of interest that includes a plurality of tee-time periods; determining, for individual tee-time periods of the plurality of tee-time periods, a forecasted demand based on a number of current tee-time reservations for each of the plurality of tee-time periods and a historical pickup value from a current time to respective tee-time periods; determining whether the individual tee-time periods are in an up category or a down category based on a comparison of the forecasted demand to respective historical demands for the individual tee-time periods; and outputting, on a graphical user interface, an indication of a number of the plurality of tee-time periods that are in the up category and a number of the plurality of tee-time periods that are in the down category.

Example 2 may include the method of example 1 or some other example herein, further comprising: determining a forecasted demand for the first period of interest based on a sum of the forecasted demands for the individual tee-time periods; and determining a pace value for the first period of interest based on a difference between the forecasted demand for the first period of interest and a historical demand for the first period of interest; and outputting, to a period summary graphic on the graphical user interface, an indication of the pace value.

Example 3 may include the method of example 2 or some other example herein, further comprising determining a number of current tee-time reservations for the first period of interest; and outputting, to the period summary graphic on the graphical user interface, indications of the number of current tee-time reservations for the first period of interest; the forecasted demand for the first period of interest; and the historical demand for the first period of interest.

Example 4 may include the method of example 2 or some other example herein, further comprising outputting, to the period summary graphic on the graphical user interface, a gauge chart to represent the pace value.

Example 5 may include the method of example 1 or some other example herein, further comprising determining, for the individual tee-time periods, true demand values based on a sum of the number of current tee-time reservations in each of the plurality of tee-time periods and the historical pickup values for the respective tee-time periods; and determining, for the individual tee-time periods, the forecasted demand based on a lesser of the true demand value or a capacity of the respective tee-time period.

Example 6 may include the method of example 1 or some other example herein, further comprising identifying a number of tee-time periods that have a true demand greater than a capacity of the respective tee-time period; and outputting, to the graphical user interface, an indication that the number of the plurality of tee-time periods are in a high-demand category.

Example 7 may include the method of example 1 or some other example herein, further comprising determining, based on a historical demand for the first period of interest, a number of tee-time periods that are in a predetermined utilization category over a plurality of golf courses; and outputting, to the graphical user interface, an indication of the number of tee-time periods that are in the predetermined utilization category.

Example 8 may include the method of example 1 or some other example herein, further comprising selecting the plurality of golf courses within a geographical region.

Example 9 may include the method of example 1 or some other example herein, wherein the first period of interest is a week, each of the plurality of tee-time periods is one hour, and the method further comprises: determining, for each day of the week, a pace value, a number of current reservations, and a historical demand; and outputting a day summary graphic for each day of the week to the graphical user interface, wherein the day summary graphic includes an indication of the pace value, number of current reservations, and historical demand for the respective day.

Example 10 may include the method of example 1 or some other example herein, further comprising outputting, in the day summary graphic for each day of the week, a gauge chart to represent the respective pace value.

Example 11 may include a method comprising determining, for individual tee-time periods of a period of interest, a true demand value based on a sum of a number of tee-times currently reserved and historical pickup values for the respective tee-time periods; selecting a first set of tee-time periods having a metric based on the respective true demand values that is within a first range; outputting a pricing adjustment for the first set of tee-time periods.

Example 12 may include the method of example 11 or some other example herein, further comprising automatically adjusting pricing of the first set of tee-time periods based on the pricing adjustment.

Example 13 may include the method of example 11 or some other example herein, wherein the metric is a percent of the true demand values to a total number historical demand of tee times within a respective tee-time period.

Example 14 may include the method of example 13 or some other example herein, wherein the first range includes values greater than 100% and the pricing adjustment is a first percentage increase in prices of the first set of tee-time periods.

Example 15 may include the method of example 13 or some other example herein, wherein the first range includes values less than 100% and the pricing adjustment is a first percentage decrease in prices of the first set of tee-time periods.

Example 16 may include a method comprising: determining a first period of interest that includes a plurality of tee-time periods; determining a selection of a predetermined utilization category; determining, based on a historical demand for the first period of interest, a first number of tee-time periods of the plurality of tee-time periods that are in the predetermined utilization category over a plurality of golf courses; and outputting, to a graphical user interface, an indication of the first number of tee-time periods that are in the predetermined utilization category.

Example 17 may include the method of example 16 or some other example herein, further comprising determining a plurality of periods of interest; determining, based on the historical demand for the plurality of periods of interest, the respective number of tee-time periods that are in the predetermined utilization category over the plurality of golf courses; and outputting, to the graphical user interface, an indication of the respective number of tee-time periods that are in the predetermined utilization category.

Example 18 may include the method of example 17 or some other example herein, wherein the plurality of periods of interest include each month of a year.

Example 19 may include the method of example 17 or some other example herein, further comprising: determining, based on the historical demand for the plurality of periods of interest, a total number of tee-time periods that are in the predetermined utilization category over the plurality of golf courses for the plurality of periods of interest; and outputting, to the graphical user interface, an indication of the total number of tee-time periods.

Example 20 may include the method of example 16 or some other example herein, further comprising: determining selections of a plurality of predetermined utilization categories; determining, based on the historical demand for the period of interest, respective number of tee-time periods that are in each of the plurality of predetermined utilization categories; and outputting, to the graphical user interface, indications of the respective number of tee-time periods that are in each of the plurality of predetermined utilization categories.

Example 21 may include a method comprising: determining, for individual tee-times, a forecasted demand based on a number of current tee-time reservations and a historical pickup value from a current time to respective tee-times; determining, for the individual tee-times, pace values based on a difference between the forecasted demands and historical demands for the individual tee-times; selecting, based on respective pace values, one or more tee times; and outputting, on a graphical interface, an indication of reservation details for the one or more tee times.

Example 22 may include the method of example 21 or some other example herein, further comprising: selecting the one or more tee times based on respective pace values being less than or greater than a predetermined threshold.

Example 23 may include the method of example 21 or some other example herein, further comprising: processing control signals from a user interface to determine the predetermined threshold.

Example 24 may include the method of example 21 or some other example herein, further comprising: adjusting respective prices of the one or more tee times; and including the adjusted prices within the indication of reservation details. Example 25 may include an apparatus comprising means to perform one or more elements of a method described in or related to any of examples 1-24, or any other method or process described herein.

Example 26 may include one or more non-transitory computer-readable media comprising instructions to cause an electronic device, upon execution of the instructions by one or more processors of the electronic device, to perform one or more elements of a method described in or related to any of examples 1-24, or any other method or process described herein.

Example 27 may include an apparatus comprising logic, modules, or circuitry to perform one or more elements of a method described in or related to any of examples 1-24, or any other method or process described herein.

Example 28 may include a method, technique, or process as described in or related to any of examples 1-24, or portions or parts thereof.

Example 29 may include an apparatus comprising: one or more processors and one or more computer readable media comprising instructions that, when executed by the one or more processors, cause the one or more processors to perform the method, techniques, or process as described in or related to any of examples 1-24, or portions thereof.

Any of the above described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

What is claimed is:

1. One or more non-transitory, computer-readable media having instructions that, when executed by one or more processors, cause a device to:
determine a first period of interest that includes a plurality of tee-time periods;
determine, for individual tee-time periods of the plurality of tee-time periods, a forecasted demand based on a number of current tee-time reservations for each of the plurality of tee-time periods and a historical pickup value from a current time to respective tee-time periods;
determine whether the individual tee-time periods are in an up category or a down category based on a comparison of the forecasted demand to respective historical demands for the individual tee-time periods; and
output, on a graphical user interface, an indication of a number of the plurality of tee-time periods that are in the up category and a number of the plurality of tee-time periods that are in the down category.

2. The one or more non-transitory, computer-readable media of claim 1, wherein the instructions, when executed, further cause the device to:
determine a forecasted demand for the first period of interest based on a sum of the forecasted demands for the individual tee-time periods;
determine a pace value for the first period of interest based on a difference between the forecasted demand for the first period of interest and a historical demand for the first period of interest; and
output, to a period summary graphic on the graphical user interface, an indication of the pace value.

3. The one or more non-transitory, computer-readable media of claim 2, wherein the instructions, when executed, further cause the device to:
determine a number of current tee-time reservations for the first period of interest; and
output, to the period summary graphic on the graphical user interface, indications of the number of current tee-time reservations for the first period of interest; the forecasted demand for the first period of interest; and the historical demand for the first period of interest.

4. The one or more non-transitory, computer-readable media of claim 2, wherein the instructions, when executed, further cause the device to:
output, to the period summary graphic on the graphical user interface, a gauge chart to represent the pace value.

5. The one or more non-transitory, computer-readable media of claim 1, wherein the instructions, when executed, further cause the device to:
determine, for the individual tee-time periods, true demand values based on a sum of the number of current tee-time reservations in each of the plurality of tee-time periods and the historical pickup values for the respective tee-time periods; and
determine, for the individual tee-time periods, the forecasted demand based on a lesser of the true demand value or a capacity of the respective tee-time period.

6. The one or more non-transitory, computer-readable media of claim 1, wherein the instructions, when executed, further cause the device to:
identify a number of tee-time periods that have a true demand greater than a capacity of the respective tee-time period; and
output, to the graphical user interface, an indication that the number of the plurality of tee-time periods are in a high-demand category.

7. The one or more non-transitory, computer-readable media of claim 1, wherein the instructions, when executed, further cause the device to:
determine, based on a historical demand for the first period of interest, a number of tee-time periods that are in a predetermined utilization category over a plurality of golf courses; and
output, to the graphical user interface, an indication of the number of tee-time periods that are in the predetermined utilization category.

8. The one or more non-transitory, computer-readable media of claim 1, wherein the instructions, when executed, further comprise selecting the plurality of golf courses within a geographical region.

9. The one or more non-transitory, computer-readable media of claim 1, wherein the first period of interest is a week, each of the plurality of tee-time periods is one hour, and the instructions, when executed, further cause the device to:
determine, for each day of the week, a pace value, a number of current reservations, and a historical demand; and
output a day summary graphic for each day of the week to the graphical user interface, wherein the day summary graphic includes an indication of the pace value, number of current reservations, and historical demand for the respective day.

10. The one or more non-transitory, computer-readable media of claim 1, wherein the instructions, when executed, further cause the device to:
output, in the day summary graphic for each day of the week, a gauge chart to represent the respective pace value.

11. One or more non-transitory, computer-readable media having instructions that, when executed by one or more processors, cause a device to:
determine, for individual tee-time periods of a period of interest, a true demand value based on a sum of a number of tee-times currently reserved and historical pickup values for the respective tee-time periods;
select a first set of tee-time periods having a metric based on the respective true demand values that is within a first range;
output a pricing adjustment for the first set of tee-time periods.

12. The one or more non-transitory, computer-readable media of claim 11, wherein the instructions, when executed, further cause the device to:
automatically adjust pricing of the first set of tee-time periods based on the pricing adjustment.

13. The one or more non-transitory, computer-readable media of claim 11, wherein the metric is a percent of the true demand values to a historical demand of tee times within a respective tee-time period.

14. The one or more non-transitory, computer-readable media of claim 13, wherein the first range includes values greater than 100% and the pricing adjustment is a first percentage increase in prices of the first set of tee-time periods.

15. The one or more non-transitory, computer-readable media of claim 13, wherein the first range includes values less than 100% and the pricing adjustment is a first percentage decrease in prices of the first set of tee-time periods.

16. One or more non-transitory, computer-readable media having instructions that, when executed by one or more processors, cause a device to:
determine a first period of interest that includes a plurality of tee-time periods;
determine a selection of a predetermined utilization category;
determine, based on a historical demand for the first period of interest, a first number of tee-time periods of the plurality of tee-time periods that are in the predetermined utilization category over a plurality of golf courses; and
output, to a graphical user interface, an indication of the first number of tee-time periods that are in the predetermined utilization category.

17. The one or more non-transitory, computer-readable media of claim 16, wherein the instructions, when executed, further cause the device to:
determine a plurality of periods of interest;
determine, based on the historical demand for the plurality of periods of interest, the respective number of tee-time periods that are in the predetermined utilization category over the plurality of golf courses; and
output, to the graphical user interface, an indication of the respective number of tee-time periods that are in the predetermined utilization category.

18. The one or more non-transitory, computer-readable media of claim 17, wherein the plurality of periods of interest include each month of a year.

19. The one or more non-transitory, computer-readable media of claim 17, wherein the instructions, when executed, further cause the device to:
determine, based on the historical demand for the plurality of periods of interest, a total number of tee-time periods that are in the predetermined utilization category over the plurality of golf courses for the plurality of periods of interest; and
output, to the graphical user interface, an indication of the total number of tee-time periods.

20. The one or more non-transitory, computer-readable media of claim 16, wherein the instructions, when executed, further cause the device to:
determine selections of a plurality of predetermined utilization categories;
determine, based on the historical demand for the period of interest, respective number of tee-time periods that are in each of the plurality of predetermined utilization categories; and
output, to the graphical user interface, indications of the respective number of tee-time periods that are in each of the plurality of predetermined utilization categories.

21. One or more non-transitory, computer-readable media having instructions that, when executed, cause a device to:
determine, for individual tee-times, a forecasted demand based on a number of current tee-time reservations and a historical pickup value from a current time to respective tee-times;
determine, for the individual tee-times, pace values based on a difference between the forecasted demands and historical demands for the individual tee-times;
select, based on respective pace values, one or more tee times; and
output, on a graphical interface, an indication of reservation details for the one or more tee times.

22. The one or more non-transitory, computer-readable media of claim 21, wherein the instructions, when executed, further cause the device to:
select the one or more tee times based on respective pace values being less than or greater than a predetermined threshold.

23. The one or more non-transitory, computer-readable media of claim 21, wherein the instructions, when executed, further cause the device to:
process control signals from a user interface to determine the predetermined threshold.

24. The one or more non-transitory, computer-readable media of claim 21, wherein the instructions, when executed, further cause the device to:
adjust respective prices of the one or more tee times; and
include the adjusted prices within the indication of reservation details.
